(19) United States
(12) Patent Application Publication
(10) Pub. No.: US 2011/0267310 A1
(43) Pub. Date: Nov. 3, 2011

(54) SENSOR APPARATUS AND INFORMATION DISPLAY APPARATUS

(75) Inventors: Tsubasa Tsukahara, Tokyo (JP); Osamu Ito, Tokyo (JP); Tetsuro Goto, Tokyo (JP); Shinobu Kuriya, Kanagawa (JP); Toshiyuki Nakagawa, Kanagawa (JP)

(73) Assignee: Sony Corporation, Tokyo (JP)

(21) Appl. No.: 13/090,398

(22) Filed: Apr. 20, 2011

(30) Foreign Application Priority Data
Apr. 28, 2010 (JP) 2010-103620

(51) Int. Cl. G06F 3/045; G06F 19/00

(52) U.S. Cl. 345/174; 702/65

(57) ABSTRACT

A sensor apparatus includes a sensor unit, a calculation unit, a switch circuit unit, and a control unit. The sensor unit has a plurality of detection electrodes each having a capacitance changed by proximity of a detection target object. The calculation unit calculates a first distance, which is a distance between the detection target object and the sensor unit. The switch circuit unit is capable of switching the detection electrodes between a first state in which a signal voltage for detecting the capacitance is supplied and a second state which is an electrically floating state, and selects at least two detection electrodes one by one switched from the second state to the first state. The control unit controls the switch circuit unit to cause a second distance, which is a distance between the detection electrodes switched from the second state to the first state, to correspond to the first distance.

### BACKGROUND OF THE INVENTION

1. Field of the Invention

The present invention relates to a sensor apparatus and an information display apparatus that detect the proximity or contact of a detection target object.

2. Description of the Related Art

Generally, a flat-type information display apparatus that uses a liquid crystal display element detects the contact of a finger or the like to a display panel surface with a touch sensor and controls a display image or an operation on the basis of coordinate information of the contact position. In recent years, in addition to the detection of a contact state, an information display apparatus capable of detecting a proximity state before a finger or the like touches a touch sensor has been proposed (see, for example, Japanese Patent Application Laid-open Nos. 2008-117371 and 2008-153025 (hereinafter, referred to as Patent Documents 1 and 2, respectively)).

For example, Patent Document 1 discloses a method for adjusting a detection resolution by changing distances among a plurality of detection electrodes in accordance with an opposed distance between a sensor means formed of the plurality of detection electrodes and a target object. Further, Patent Document 2 discloses a method for electrically connecting a plurality of detection electrodes with each other in the case where a detection target object which exists in a distant position is detected and separating a plurality of detection electrodes electrically connected in the case where a detection target object which exists in a nearby position is detected.

### SUMMARY OF THE INVENTION

However, the information display apparatus disclosed in Patent Document 1 has a problem in that it may be impossible to increase a distance for the detection of the target object due to the influence of electrostatic binding between the detection electrodes. Further, the structure disclosed in Patent Document 2 provides a low degree of freedom in terms of the configuration or arrangement of the detection electrodes, so the detection distance or sensitivity is significantly restricted by the size of a detection area.

In view of the above-mentioned circumstances, it is desirable to provide a sensor apparatus and an information display apparatus that are capable of improving a detectable distance and a detection sensitivity.

According to an embodiment of the present invention, there is provided a sensor apparatus including a sensor unit, a calculation unit, a switch circuit unit, and a control unit.

The sensor unit is configured to have a plurality of detection electrodes each having a capacitance that is changed by proximity of a detection target object.

The calculation unit is configured to calculate a first distance, the first distance being a distance between the detection target object and the sensor unit.

The switch circuit unit is capable of switching the plurality of detection electrodes between a first state and a second state, and is configured to select at least two detection electrodes one by one that are switched from the second state to the first state from among the plurality of detection electrodes. The first state is a state in which a signal voltage for detecting the capacitance is supplied, and the second state is an electrically floating state.

The control unit is configured to control the switch circuit unit to cause a second distance to correspond to the first distance calculated by the calculation unit, the second distance being a distance between the detection electrodes switched from the second state to the first state.

In the sensor apparatus, on the basis of the change in capacitance of the detection electrodes switched to the first state, the proximity of the detection target object to the sensor unit is detected. A relative distance (first distance) between the sensor unit and the detection target object is calculated by the calculation unit. At this time, the remaining detection electrodes other than the detection electrodes switched to the first state are maintained to be the second state that is the electrically floating state by the switch circuit unit, so the capacitance between the detection electrodes in the first state and the remaining detection electrodes is reduced. Thus, a detection sensitivity for the detection target object by the sensor unit can be improved.

Further, in the sensor apparatus, at least two detection electrodes having an electrode distance (second distance) corresponding to the first distance are switched from the second state to the first state one by one. As a result, it is possible to ensure a stable detection sensitivity regardless of a proximity distance of the detection target object and increase a detectable distance.

The calculation unit may be formed of a calculation circuit that calculates the first distance by detecting the change in the capacitance of the detection electrode. Further, the calculation unit may be formed of an image pickup device that directly detects the first distance, a sensor device that optically detect the same, or the like.

The plurality of detection electrodes each may be configured to have a plurality of first electrode units arranged at a first interval in a first direction. In this case, the control unit may be configured to control the switch circuit unit to change the second distance by an integral multiple of the first interval in accordance with the first distance.

As a result, it is possible to detect the position or the movement of the detection target object in the first direction. In addition, by increasing or decreasing the number of detection electrodes switched to the first state, the detection sensitivity in accordance with the proximity distance of the detection target object can be obtained.

The plurality of detection electrodes each may be configured to further have a plurality of second electrode units arranged at a second interval in a second direction that intersects the first direction. In this case, the control unit may be configured to control the switch circuit unit to change the second distance by an integral multiple of the second interval in accordance with the second distance.

As a result, it is possible to detect the position or the movement of the detection target object in the second direction. In addition, by increasing or decreasing the number of detection electrodes switched to the first state, the detection sensitivity in accordance with the proximity distance of the detection target object can be obtained.

According to another embodiment of the present invention, there is provided an information display apparatus including a sensor unit, a calculation unit, a switch circuit unit, a control unit, and a display device.

The sensor unit is configured to have a plurality of detection electrodes each having a capacitance that is changed by proximity of a detection target object.

The calculation unit is configured to calculate a first distance, the first distance being a distance between the detection target object and the sensor unit.

The switch circuit unit is capable of switching the plurality of detection electrodes between a first state and a second state, and is configured to select at least two detection electrodes one by one that are switched from the second state to the first state from among the plurality of detection electrodes. The first state is a state in which a signal voltage for detecting the capacitance is supplied, and the second state is an electrically floating state.

The control unit is configured to control the switch circuit unit to cause a second distance to correspond to the first distance calculated by the calculation unit, the second distance being a distance between the detection electrodes switched from the second state to the first state.

The display device is disposed to be opposed to the sensor unit, and is configured to have a display surface that displays information.

According to the embodiments of the present invention, it is possible to improve the detectable distance and the detection sensitivity for the detection target object.

These and other objects, features and advantages of the present invention will become more apparent in light of the following detailed description of best mode embodiments thereof, as illustrated in the accompanying drawings.

### BRIEF DESCRIPTION OF DRAWINGS

FIG. 1 is a block diagram showing the structure of a sensor apparatus according to an embodiment of the present invention;

FIG. 2 is an exploded perspective view showing the schematic structure of a sensor unit of the sensor apparatus;

FIG. 3 is a schematic circuit diagram showing the relationship among the sensor unit, a switch circuit unit, and a calculation unit of the sensor apparatus;

FIG. 4 are diagrams for explaining the relationship between a distance from the sensor unit to a detection target object and a scanning interval of detection electrodes;

FIG. 5 is a schematic diagram showing an example of a working of the sensor apparatus;

FIG. 6 is a flowchart for explaining an operation example of the sensor apparatus;

FIG. 7 are simulation models for explaining oscillation conditions when field intensity distributions on an oscillation electrode are measured in different oscillation methods;

FIG. 8 is a diagram showing the simulation result of FIG. 7;

FIG. 9 is a simulation model for explaining a method for measuring the rate of change in capacitance between an electrode and the detection target object with an electrode pitch and the height of the detection target object being changed;

FIG. 10 is a diagram showing the simulation result of FIG. 9;

FIG. 11 is a schematic diagram showing a sensor apparatus according to a second embodiment of the present invention;

FIG. 12 is a schematic diagram showing a sensor apparatus according to a third embodiment of the present invention;

FIG. 13 is a schematic diagram showing a sensor apparatus according to a fourth embodiment of the present invention; and

FIG. 14 is a schematic plan view showing a modified example of an electrode forms of the sensor unit.

### DESCRIPTION OF PREFERRED EMBODIMENTS

Hereinafter, embodiments of the present invention will be described with reference to the drawings.

### First Embodiment

(Sensor Apparatus)

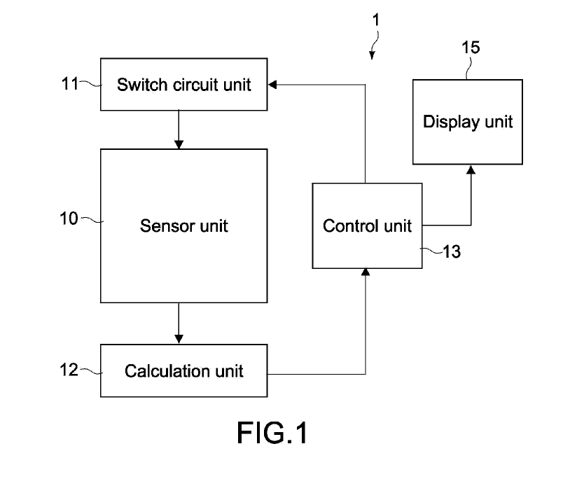

FIG. 1 is a block diagram showing the structure of a sensor apparatus according to an embodiment of the present invention. A sensor apparatus 1 of this embodiment includes a sensor unit 10, a switch circuit unit 11, a calculation unit 12, a control unit 13, and a display unit 15. The sensor apparatus 1 functions as a detection apparatus of an input coordinate position, for example, and constitutes an input interface of an information display apparatus that controls a display image in accordance with the input coordinate position.

(Sensor Unit)

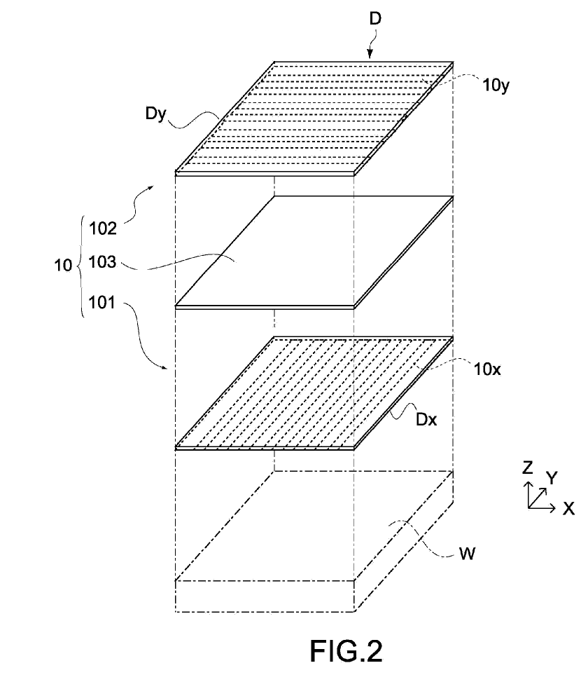

FIG. 2 is an exploded perspective view showing the schematic structure of the sensor unit 10. The sensor unit 10 has a laminated structure of a first electrode substrate 101, a second electrode substrate 102, and a bonding layer 103, which bonds the electrode substrates 101 and 102 to each other. The sensor unit 10 detects positional coordinates of a detection target object on an XY plane shown in FIG. 2, and is configured as a capacitive touch sensor or proximity sensor. The detection target object in this embodiment is a person's finger as an example, but the detection target object includes an auxiliary input device such as a stylus pen.

The first electrode substrate 101 has a plurality of detection electrodes 10x and a support base member Dx for supporting the detection electrodes 10x. The detection electrodes 10x are formed of linear wiring electrodes that are extended in parallel to a Y-axis direction (longitudinal direction) in FIG. 2, and are arranged in an X-axis direction (transverse direction) perpendicular to the Y-axis direction at predetermined intervals. The detection electrodes 10x detect the position of a person's finger along the X-axis direction.

The second electrode substrate 102 has a plurality of detection electrodes 10y and a support base member Dy for supporting the detection electrodes 10y. The detection electrodes 10y are formed of linear wiring electrodes that are extended in parallel to the X-axis direction, and are arranged in the Y-axis direction at predetermined intervals. The detection electrodes 10y detect the position of a person's finger along the Y-axis direction.

In this embodiment, the second electrode substrate 102 is disposed above the first electrode substrate 101, but the arrangement is not limited to this. The first electrode substrate 101 may be disposed on the upper layer side. The uppermost surface of the second electrode substrate 102 forms a detection surface D on which the detection electrodes the detection electrodes 10x and 10y are arranged in a matrix pattern, and is formed of a transparent substrate that covers the second electrode substrate 102, for example.

The detection electrodes 10x and 10y and the support base members Dx and Dy may be made of a translucent material or a non-translucent material. For example, as shown in FIG. 2, in the case where the sensor unit 10 is laminated on a display surface of a display device W, in order to allow a display image to be visually recognized from outside, members that constitute the sensor unit 10 are made of a translucent material. In this case, the detection electrodes 10x and 10y are made of a transparent conductive oxide such as an ITO (indium tin oxide), and the support base members Dx and Dy are made of a translucent resin material such as PET (polyethylene terephthalate), PEN (polyethylene naphthalate), and PC (polycarbonate). In contrast, in the case where the sensor unit 10 is disposed on the back surface side of the display device W, the sensor unit 10 does not have to be translucent, and therefore can be made of a non-translucent material.

The switch circuit unit 11 drives the sensor unit 10 by supplying a signal voltage to the detection electrodes 10x and 10y. The supplying of the signal voltage causes the sensor unit 10 to generate a detection signal relating to the proximity or contact of a finger to the detection surface D or a relative position of a finger with respect to the detection surface D and output the detection signal to the calculation unit 12.

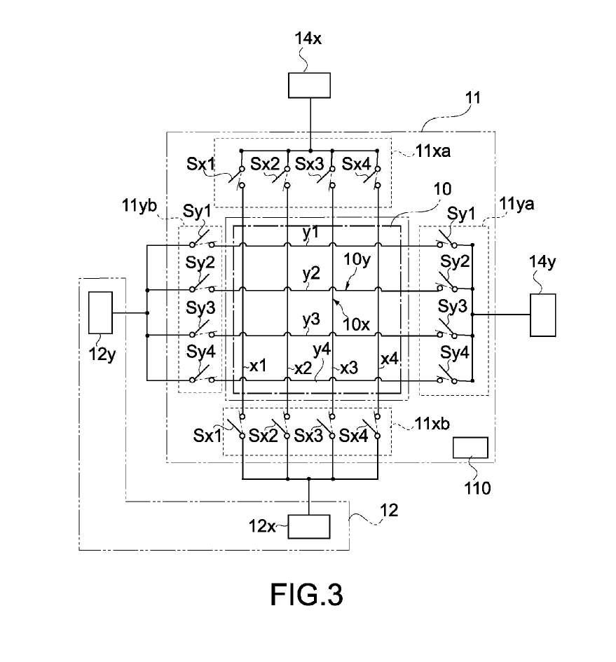

FIG. 3 is a schematic circuit diagram showing the relationship among the sensor unit 10, the switch circuit unit 11, and the calculation unit 12. For simplification, in the figure, the numbers of detection electrodes 10x and 10y of sensor unit 10 are set to four, respectively. In actuality, more detection electrodes 10x and 10y are arranged.

(Switch Circuit Unit)

The switch circuit unit 11 has a first switch group 11xa and 11xb including a plurality of switches provided so as to be corresponded to the respective detection electrodes 10x and a second switch group 11ya and 11yb including a plurality of switches provided so as to be corresponded to the respective detection electrodes 10y.

The first switch groups 11xa and 11xb have switches (Sx1, Sx2, Sx3, and Sx4) provided to the both ends of the individual detection electrodes 10x (x1, x2, x3, and x4), respectively. Two switches (Sx1, Sx2, Sx3, and Sx4) connected to the same detection electrodes 10x (x1, x2, x3, and x4) are configured so as to be opened and closed in synchronization with each other. Out of the first switch group, the switch group 11xa on one side is connected to a first signal generation circuit 14x, and the switch group 11xb on the other side is connected to a first calculation circuit 12x.

On the other hand, the second switch groups 11ya and 11yb have switches (Sy1, Sy2, Sy3, and Sy4) provided to the both ends of the individual detection electrodes 10y (y1, y2, y3, and y4), respectively. Two switches (Sy1, Sy2, Sy3, and Sy4) connected to the same detection electrodes 10y (y1, y2, y3, and y4) are configured so as to be opened and closed in synchronization with each other. Out of the second switch group, the switch group 11ya on one side is connected to a second signal generation circuit 14y, and the switch group 11yb on the other side is connected to a second calculation circuit 12y.

The signal generation circuits 14x and 14y may be included in the switch circuit unit 11 or may be provided separately from the switch circuit unit 11. The signal generation circuits 14x and 14y are structured by an oscillation circuit or a power supply circuit that generates a signal voltage for driving the detection electrodes 10x and 10y. The signal voltage in this embodiment is a pulse voltage that oscillates at a predetermined frequency, but is not limited to this. The signal voltage may be a DC voltage or an AC voltage at a predetermined frequency including a high frequency. The calculation circuits 12x and 12y are included in the calculation unit 12 to be described later.

The switches that constitute the switch group 11xa have a first state in which the detection electrodes 10x (x1, x2, x3, and x4) and the signal generation circuit 14x are electrically connected with each other and a second state in which the detection electrodes 10x and the signal generation circuit 14x are electrically shut off. The switches that constitute the switch group 11xb have a first state in which the detection electrodes 10x (x1, x2, x3, and x4) and the calculation circuit 12x are electrically connected with each other and a second state in which the detection electrodes 10x and the calculation circuit 12x are electrically shut off. In the first state, the oscillation is caused by supplying a signal voltage to the detection electrodes 10x (x1, x2, x3, and x4), and the calculation circuit 12x detects the capacitance of a detection electrode (hereinafter, also referred to as “oscillation electrode”) to which the signal voltage is supplied and a change thereof.

The switch group 11xa selects one from among the switches (Sx1, Sx2, Sx3, and Sx4). The selection in this case means selecting a switch for switching from the second state to the first state. The switch selected connects, to the signal generation circuit 14, the detection electrode connected to the switch, and supplies the signal voltage to the detection electrode. At this time, the switch group 11xa switches the other switches to the second state, and shuts off the signal voltage to the detection electrodes connected to those switches.

When one switch is selected from the switch group 11xa on one side, in response to this, a corresponding switch of the switch group 11xb on the other side is switched to the same state as the aforementioned switch. For example, when the switch Sx1 of the switch group 11xa is switched to the first state, the switch Sx1 of the switch group 11xb is also switched to the first state, and the remaining switches Sx2 to Sx4 of the switch group 11xb are switched to the second state. Therefore, when one detection electrode is selected by the switch groups 11xa and 11xb, an output signal from the detection electrode is supplied to the calculation circuit 12x, and the remaining detection electrodes are shifted to an electrically floating state. Thus, it becomes possible to highly sensitively detect the capacitance of the oscillation electrode with the influence of the electrostatic binding between the detection electrodes 10x being suppressed.

The switch groups 11ya and 11yb are configured in the same way as above. That is, when one detection electrode is selected by the switch groups 11ya and 11yb, an output signal from the detection electrode is supplied to the calculation circuit 12y, and the calculation circuit 12y detects the capacitance of the detection electrode to which the signal voltage is supplied and a change thereof. The remaining detection electrodes are shifted to the electrically floating state by bringing the switches of the respective switch groups into the second state. Thus, it becomes possible to highly sensitively detect the capacitance of the oscillation electrode with the influence of the electrostatic binding between the detection electrodes 10y prevented.

The switches that constitute the switch groups 11xa, 11xb, 11ya, and 11yb are not particularly limited, as long as the detection electrodes can be brought into the floating state in the second state. For example, the switches may be electromechanical switches, which use a mechanical contact point, or may be semiconductor switches, which use a field-effect transistor (FET), a PIN diode, or the like. The electromechanical switch does not generate a switch capacity in principle, so a desired floating state can be achieved. On the other hand, the semiconductor switch can provide a desired floating state by using a device having a small switch capacity. As the semiconductor switch of this type, for example, a single-pole-single-throw (SPST) switch “ADG1206” (product name) manufactured by Analog Devices, Inc. can be used.

The switch groups 11xa and 11xb and the switch groups 11ya and 11yb select two or more switches from the plurality of switches one by one. Typically, the switch groups 11xa and 11xb sequentially oscillate the detection electrodes 10x by switching the switches Sx1 to Sx4 to the first state one by one, thereby making it possible to detect the position of a finger along the X-axis direction above the detection surface D. Similarly, the switch groups 11ya and 11yb sequentially oscillate the detection electrodes 10y by switching the switches Sy1 to Sy4 to the first state one by one, thereby making it possible to detect the position of a finger along the Y-axis direction above the detection surface D. The switch circuit unit 11 has a controller 110 that receives an output from the control unit 13 and performs overall control of the switches.

The sensor apparatus 1 of this embodiment changes a switch to be selected in accordance with the relative distance between the detection surface D and a finger, thereby adjusting a scanning interval between the detection electrodes 10x, 10y. In this case, the scanning interval refers to an interval between switches switched from the second state to the first state, that is, an interval between the oscillation electrodes. The sensor apparatus 1 of this embodiment makes an adjustment so that the scanning intervals between the detection electrodes 10x and between the detection electrodes 10y become larger (coarser), as a finger is distanced from the detection surface D as will be described later. In contrast, the sensor apparatus makes an adjustment so that the scanning interval between the detection electrodes 10x and between the detection electrodes 10y become smaller (denser), as a finger becomes closer to the detection surface D.

(Calculation Unit)

The calculation unit 12 has the calculation circuit 12x that processes the signal voltage output from the detection electrodes 10x and the calculation circuit 12y that processes the signal voltage output from the detection electrodes 10y. The signal voltage output from each of the detection electrodes 10x and 10y corresponds to a detection signal including information of the existence of a finger or the position thereof above the detection surface D. On the basis of the detection signals of the detection electrodes 10x and 10y, the calculation circuits 12x and 12y calculate the existence or nonexistence of a finger above the detection surface D, or in the case where a finger is existed, calculate the distance from the detection surface D, the position of the XY coordinates, the movement direction, and the movement speed (or acceleration).

On the basis of the detection signals of the detection electrodes 10x and 10y selected by the switch circuit unit 11, the calculation circuits 12x and 12y detect the capacitance of the detection electrodes 10x and 10y concerned, and calculates the distance (first distance) corresponding to the capacitance. A detection method of the capacitance is not particularly limited, and a known method can be employed. Further, on the basis of the change in capacitance, it is possible to specify the proximity of a finger or the position coordinates.

In this embodiment, by a detection method called self capacitance method, the capacitance of each of the detection electrodes 10x and 10y is individually detected. The self capacitance method is also called as single-electrode method, which uses one electrode for sensing. The electrode for sensing has a floating capacity with respect to a ground potential. If a detection target object that is grounded, such as a human body (finger), approaches the electrode, the floating capacity of the electrode is increased. The calculation unit 12 calculates the position coordinate and the proximity of a finger by detecting the increase of the capacity.

(Control Unit)

The control unit 13 controls the operation of the sensor apparatus 1. Hereinafter, the control unit 13 will be described in detail.

The control unit 13 obtains, from the calculation unit 12, distance information of a finger from the detection surface D, and controls the switch circuit unit 11 on the basis of the distance information. The control unit 13 adjusts the scanning interval (second distance) of the detection electrodes 10x, 10y through the switch circuit unit 11. In this embodiment, the control unit 13 controls the switch circuit unit 11 so that the scanning interval of the detection electrodes 10x, 10y corresponds to the distance of a finger from the detection surface D.

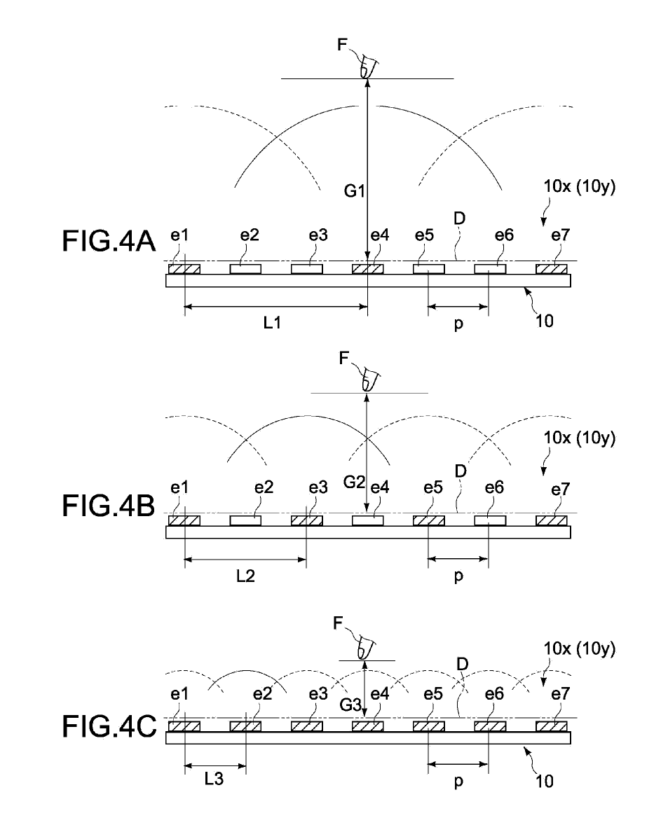

FIGS. 4A to 4C are diagrams for explaining the relationship between a distance G (G1, G2, and G3) from the detection surface D to a finger F and a scanning interval L (L1, L2, L3) of the detection electrodes. Here, the electrodes that constitute the detection electrodes 10x and 10y are set to electrodes e1 to e7, respectively. The number of electrodes is not limited to the example of the figure. It should be noted that electrodes to be scanned are hatched in FIGS. 4A to 4C (the same holds true for FIG. 5).

As described above, the control unit 13 controls the switch circuit unit 11 on the basis of the distance information relating to the finger F, which is obtained from the calculation unit 12, thereby adjusting the scanning interval of the detection electrodes 10x. Then, as shown in FIG. 4A, in the case where the distance G from the finger F is G1, the scanning interval L of the detection electrodes 10x is adjusted to L1 so as to be equal to G1. Similarly, as shown in FIGS. 4B and 4C, in the case where the distance G is G2, the scanning interval is adjusted to L2, and in the case where the distance G is G3, the scanning interval is adjusted to L3.

Here, although the distance G of the finger F continuously changes, the scanning interval L of the detection electrode is a discrete value, because the electrodes x1 to x9 are arranged at constant pitches (p) in the X-axis direction. Therefore, the scanning interval of the detection electrodes is determined to be a value that is an integral multiple of the electrode pitch p and is the closest to the distance G. In this way, the scanning interval L of the detection electrodes is changed on the basis of the integral multiple of the electrode pitch p in accordance with the change of the distance G between the finger F and the detection surface D.

Further, the maximum scanning interval of the detection electrodes 10x and 10y in the case where the finger F does not exist above the detection surface D is appropriately set in accordance with a requisite detectable distance or the like, for example, set to the interval every two to five electrodes. In this embodiment, for ease of explanation, the scanning intervals shown in FIG. 4A is set as the maximum scanning interval.

The electrodes to be scanned are scanned at a certain period one by one. The detection electrodes 10x and the detection electrodes 10y are set to have the same scanning period, for example, 16.7 msec per field. The detection electrodes 10x and the detection electrodes 10y are alternately scanned. A field period in the case where the scanning interval is adjusted is set to be invariable, but is not limited to this.

FIG. 5 is a schematic diagram showing the scanning mode shown in FIG. 4 in terms of the relationship with the switch circuit unit 11. The switch circuit unit 11 selects two or more electrodes (e1, e3, e5, e7) as the scanning target one by one on the basis of a command from the control unit 13. FIG. 5 shows a state where the electrode e3 is selected. In this case, the other electrodes (e1, e2, e4 to e7) are in the floating state.

It should be noted that the switch circuit unit 11 has the controller 110 for performing overall control of the switches as described above, but the controller 110 may be configured as a part of the control unit 13. In the same way, the calculation unit 12 may also be a part of the control unit 13. The switch circuit unit 11, the calculation unit 12, and the control unit 13 may be configured by a common semiconductor chip (IC chip).

The control unit 13 may further have a storage unit for storing the positional coordinates, the movement direction, the movement speed, the distance, and the like of the finger calculated by the calculation unit 12. In addition, the control unit 13 may have a function for determining the gesture of the finger on the basis of the physical amounts stored, and generating a predetermined control signal. The aforementioned control signal includes a general signal for controlling the operation of an apparatus such as control or the like of a display image. Thus, it becomes possible to control the apparatus relevant to a specific operation of the finger while automatically making an optimal adjustment of the sensor unit 10 in accordance with the position of the finger.

In this embodiment, the control unit 13 generates the control signal on the basis of the finger's operation detected by the sensor unit 10, and controls an image displayed on the display unit 15. For example, the size of an icon is changed in accordance with the proximity of the finger toward the detection surface D, or the movement of a pointer or a scroll operation on a screen is controlled in accordance with the movement of the finger above the detection screen D.

(Display Unit)

The display unit 15 includes the display device W having a display surface on which an image is displayed. For the display device W, for example, an image display device such as a liquid crystal display panel, an organic EL panel, and a cathode ray tube (CRT) is used. The display unit 15 controls an image displayed on the display surface on the basis of the control signal supplied from the control unit 13. The display unit 15 may be disposed on a position physically distanced from the sensor unit 10 or may be configured integrally with the sensor unit 10.

(Operation Example of Sensor Apparatus)

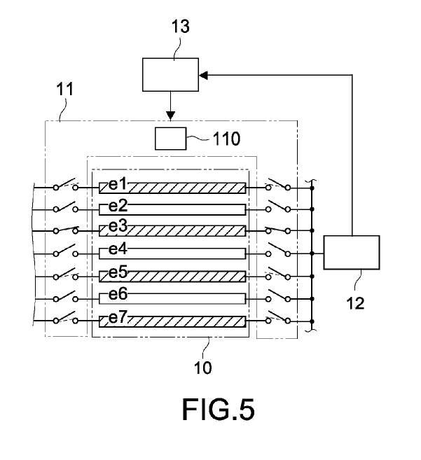

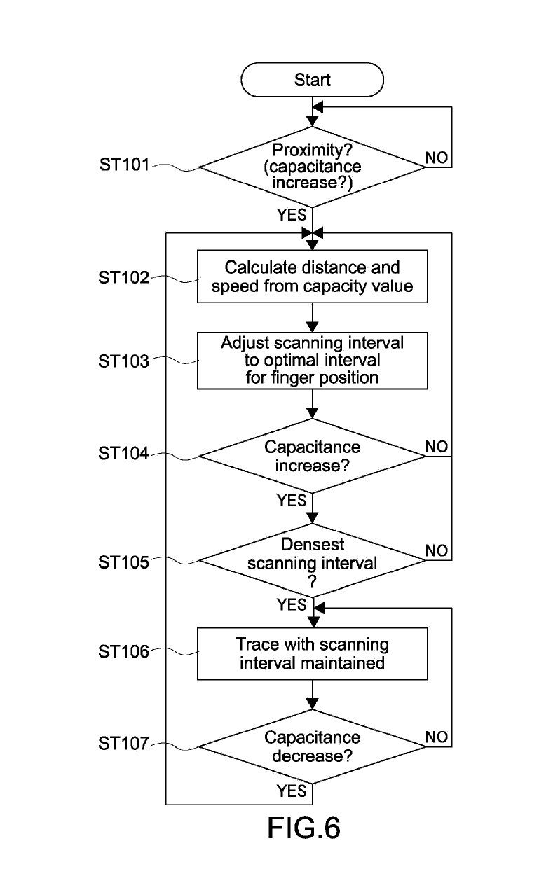

Next, a description will be given on an operation example of the sensor apparatus 1 configured as described above. FIG. 6 is an example of a control flow of the sensor apparatus 1.

The control unit 13 controls the switch circuit unit 11 to drive the sensor unit 10 at the maximum scanning interval shown in FIG. 4A. As a result, the detection electrodes 10x and 10y are oscillated at the predetermined interval one by one, and the capacitance of each of the oscillation electrodes and the change thereof are calculated by the calculation unit 12 (calculation circuits 12x and 12y). The aforementioned operation is repeatedly performed until the capacitances of the oscillation electrodes exceed a predetermined value (first threshold value) (Step 101).

When the finger approaches the detection surface D, the floating capacity of an oscillation electrode which is in proximity to the finger increases. In the case where the floating capacity of the oscillation electrode concerned exceeds the predetermined value (first threshold value), the control unit 13 determines that the finger is in proximity to the detection surface D of the sensor unit 10. At this time, from the value of the capacity output from the oscillation electrode, not only the proximity distance of the finger but also the movement direction and the movement speed of the finger are calculated in the calculation unit 12, and the calculation results are supplied to the control unit 13 (Step 102). The control unit 13 generates a control signal on the basis of information relating to the movement of the finger which is output from the calculation unit 12 and controls a display image of the display unit 15.

Subsequently, on the basis of the distance information of the finger that is calculated by the calculation unit 12, the scanning interval of the detection electrodes 10x and 10y is adjusted to be an optimal interval for the position of the finger (Step 103). That is, the control unit 13 controls the switch circuit unit 11 so that the scanning interval of the detection electrodes 10x and 10y corresponds to the distance from the detection surface D to the finger.

For example, if the distance from the detection surface D to the finger F is changed from G1 to G2 as shown in FIG. 4B, the floating capacity of the oscillation electrode is further increased. The capacitance exceeds a predetermined value (second threshold value), the control unit 13 controls the switch circuit unit 11, thereby adjusting the scanning interval of the detection electrodes 10x and 10y from L1 to L2. As a result, the position of the detection electrode to be oscillated is changed, and the scanning interval is set not every two detection electrodes before the adjustment but every other detection electrode, with the result that detection sensitivity of the proximity position of the finger F is increased. That is, it is possible to improve detection accuracy of X, Y, Z positional coordinates of the finger with respect to the detection surface D.

The adjustment of the scanning interval of the detection electrodes 10x and 10y may not necessarily be based only on the distance information (capacitance value) of the finger. For example, the scanning interval of the detection electrode may be adjusted on the basis of approaching speed (rate of change of Z positional coordinate) or the like of the finger.

The control unit 13 judges whether the finger further approaches the detection surface or not on the basis of the increase in capacitance of the detection electrode oscillated at the scanning interval L2 (Step 104). In the case where the increase in the capacitance is not recognized, it is found that the distance from the detection surface D to the finger does not change or the finger moves away from the detection surface. In this case, the processes of Steps 102 and 103 are repeated again, and the sensor unit 10 is adjusted to the optimal scanning interval in accordance with the distance of the finger.

On the other hand, in the case where the increase in the capacitance of the oscillation electrode is recognized in Step 104, it is found that the finger further approaches the detection surface D or touches the detection surface. Then, the control unit 13 judges whether the current scanning interval of the detection electrodes 10x and 10y is minimum (densest) or not (Step 105). At this time, in the case where the scanning interval is not minimum, the processes of Steps 102 to 104 are performed again. For example, in the case where the further increase in the capacitance of the oscillation electrode in the state shown in FIG. 4B, and the proximity distance of the finger is changed from G2 to G3, the control unit 13 controls the switch circuit unit 11 to adjust the scanning interval of the detection electrodes 10x and 10y from L2 to L3 as shown in FIG. 4C. As a result, all the detection electrodes 10x and 10y are set as the scanning target, and it becomes possible to further improve the position detection accuracy of the finger in the vicinity of the detection surface D.

When the scanning interval of the detection electrodes 10x and 10y is set to the minimum interval, the control unit 13 traces the movement of the finger while maintaining the scanning interval (Step 106). Thus, the control signal based on the movement of the finger above the detection surface D is generated. As the control signal in this case, for example, the movement control of a pointer on the display screen, screen scrolling, page turning, or the like is included.

On the other hand, it is possible to judge that the finger moves away from the detection surface D on the basis of the decrease in capacitance of the oscillation electrode (Step 107). In the case where the decrease in the capacitance is recognized, the process returns to Step 102, and the control unit 13 performs again the operation described above, thereby selecting the detection electrodes 10x and 10y that provides the scanning interval corresponding to the distance by which the finger moves away. On the other hand, in the case where the decrease in the capacitance of the oscillation electrode is not recognized, the control unit 13 continues the operation of Step 106 and generates the control signal corresponding to the movement form of the finger.

As described above, in the sensor apparatus 1 of this embodiment, the detection electrodes 10x and 10y are oscillated one by one, and the remaining detection electrodes other than the oscillation electrode are maintained to be in the electrically floating state (second state) by the switch circuit unit 11. Therefore, the capacitance between the oscillation electrode and the remaining electrodes is reduced, and a field intensity generated from each oscillation electrode is increased, with the result that the finger at a larger distance can be detected. Thus, it is possible to improve the detection sensitivity and the detectable distance of the finger by the sensor unit 10.

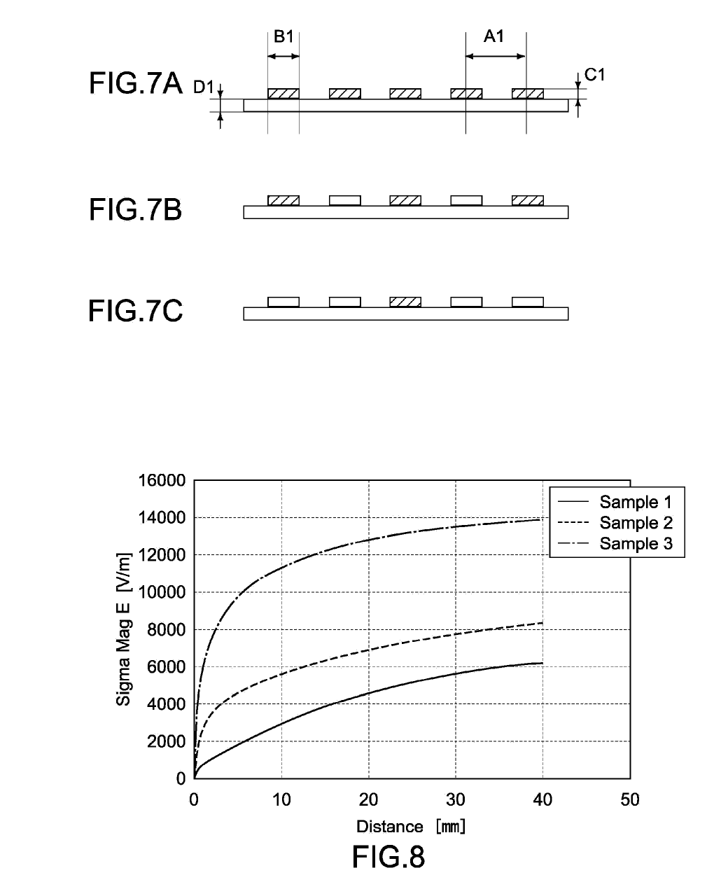

Here, FIGS. 7 and 8 show simulation models for explaining oscillation conditions at a time when a field intensity distribution on the oscillation electrodes in different oscillation methods and the simulation results thereof, respectively.

FIG. 7A shows a sample model (sample 1) in which five electrodes arranged on a substrate at constant pitches are entirely oscillated at the same time. FIG. 7B shows a sample model (sample 2) in which a central electrode and electrodes on both ends farthest therefrom are oscillated at the same time, and the remaining electrodes are brought into the floating state. FIG. 7C shows a sample model (sample 3) in which only a central wiring electrode is oscillated, and the remaining electrodes are brought into the floating state.

FIG. 8 shows the results obtained by measuring a field intensity generated from the central electrodes for each sample and calculating the integral of each of the field intensities with respect to an upward distance from a target electrode. It has been electromagnetically proved that the integral is proportional to a capacitance generated between the electrode and a detection target object such as a finger, and the larger the integral, the higher the detection sensitivity becomes.

It should be noted that the structures of the electrodes in each sample are set to be the same. A electrode pitch (A1) is set to 5 mm, an electrode width (B1) is set to 0.3 mm, an electrode thickness (C1) is set to 0.04 mm, a substrate thickness (D1) is set to 1 mm, and an applied voltage is set to 1 V. For the simulator, “Maxwell 3D” manufactured Ansoft Corporation is used.

As is apparent from the results shown in FIG. 8, in the case of the sample 1, the field intensity is the smallest at the farthest position. In contrast, in the case of the sample 3, the field intensity is the largest at the farthest position. This shows that the detection target object such as a finger can be detected most desirably.

As described above, only one oscillation electrode is oscillated, and the remaining electrodes are brought into the floating state, with the result that the detection sensitivity and the detectable distance of the detection target object can be improved.

Further, in this embodiment, the scanning interval (second distance) of the detection electrodes 10x and 10y is adjusted to the length corresponding to the proximity distance (first distance) of the finger with respect to the detection surface D. As a result, it is possible to ensure a stable detection sensitivity regardless of the proximity distance of the finger and expand the detectable distance of the finger.

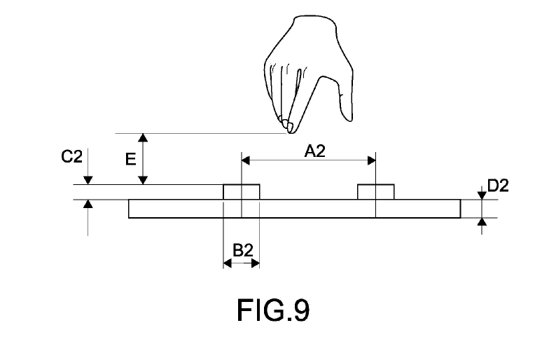

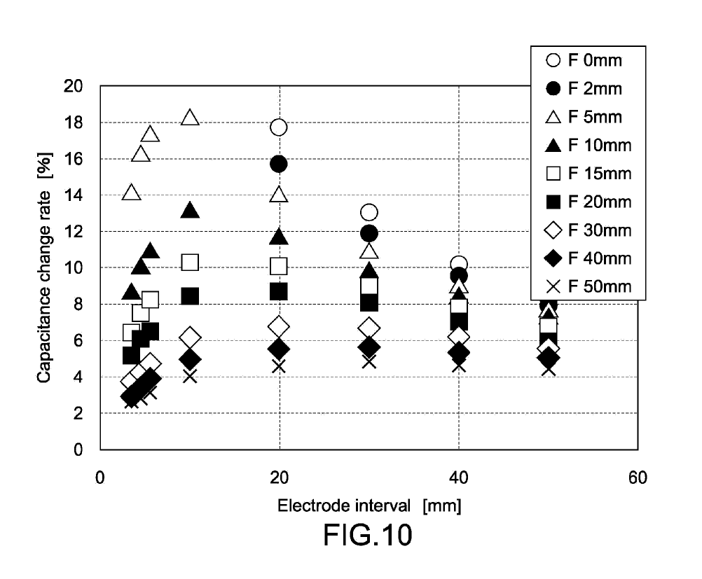

For example, as shown in FIG. 9, the rate of change in capacitance between the finger and the electrode at the time was obtained by a simulation, when an electrode pitch (A2) is gradually increased, and the height of the finger is changed. FIG. 10 shows the result.

It should be noted that the electrode pitch (A2) is set to 0 to 50 mm, an electrode width (B2) is set to 1 mm, an electrode thickness (C2) is set to 0.04 mm, the height of the finger (E) is set to 0 to 50 mm, a substrate thickness (D2) is set to 1 mm, and an applied voltage is set to 1 V. For the simulator, “Maxwell 3D” manufactured Ansoft Corporation is used.

As shown in FIG. 10, for example, in the case where the height of the finger is 10 mm (F 10 mm), the largest rate of change is obtained when the electrode interval is approximately 10 mm, and thus the finger is likely to be detected. In the case where the height of the finger is 50 mm (F 50 mm), the largest rate of change is obtained when the electrode interval is approximately 50 mm. Thus, there is a certain correlation between the height of the finger and the electrode interval. It is found that the electrode interval (scanning interval) is set to be the same as the height of the finger to be detected, thereby maintaining the detection sensitivity to be the most desirable.

Further, in this embodiment, the detection electrodes 10x and 10y are formed in the wiring pattern. Therefore, by adjusting the width of the wiring or the number of wirings, the desired detection sensitivity can be obtained. In addition, by adjusting the scanning interval of the detection electrodes, the predetermined detection sensitivity can be obtained regardless of the proximity distance. Further, because a high degree of freedom of the arrangement of the detection electrodes is provided, so it is possible to ensure the stable detection sensitivity which is unlikely to be affected by the size of the detection area.

Furthermore, according to this embodiment, the movement of a plurality of fingers above the detection surface D can be detected. For example, on the basis of a combined movement of a thumb and a forefinger, zooming control or rotation control of a screen is performed.

### Second Embodiment

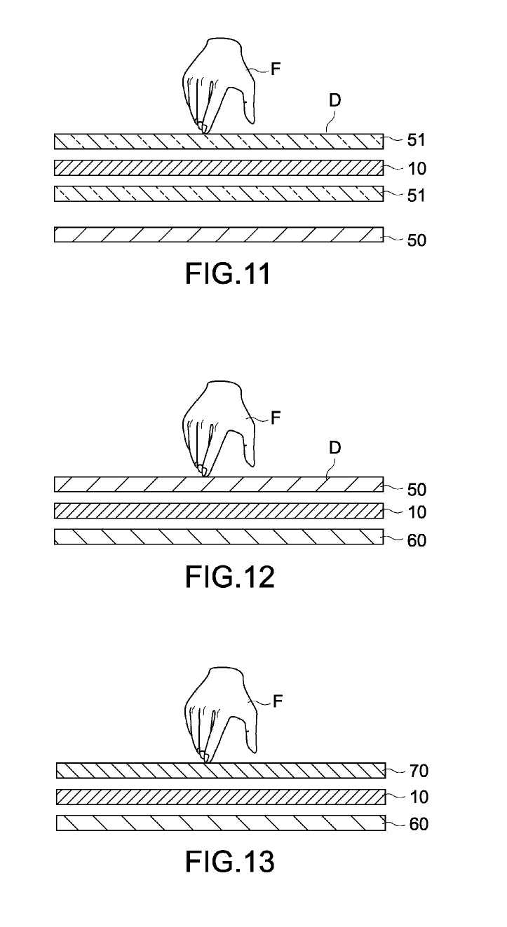

Next, a second embodiment of the present invention will be described. FIG. 11 is a schematic structural diagram of a sensor apparatus according to this embodiment.

The sensor apparatus of this embodiment has the sensor unit 10 described above and a display device 50. The sensor unit 10 is disposed between two transparent base members 51, and the display device 50 is formed of a liquid crystal panel or an organic EL panel having a display surface for displaying information such as characters or figures, which is disposed so as to be opposed to the back surface of the sensor unit 10. A display image of the display device 50 is controlled on the basis of a detection output of the sensor unit 10. The sensor apparatus according to this embodiment is applied to a mobile information processing terminal typified by a mobile phone. The other structures (switch circuit unit 11, calculation unit 12, and control unit 13) except the sensor unit 10 are stored in the main body of the terminal, although the structures are not shown.

The transparent base member 51 is formed of a translucent, electrically insulating substrate such as a glass substrate and a plastic substrate. The structural members (detection electrodes 10x and 10y, and support base members Dx and Dy) of the sensor unit 10 are made of a translucent material, and therefore, the display image of the display element 50 can be visually recognized from outside. The transparent base member 51 that covers an upper surface of the sensor unit 10 forms the detection surface D of the sensor unit 10.

According to this embodiment, it is possible to perform a necessary input operation only by moving the finger F above the detection surface D while holding the terminal with the hand. Further, the proximity of the finger F and the movement thereof can be detected with high sensitivity by the sensor unit 10, with the result that appropriate image display control can be performed on the basis of the input operation only by holding the finger over the detection surface D in addition to touching the detection surface D by the finger.

### Third Embodiment

FIG. 12 is a schematic structural diagram showing a sensor apparatus according to a third embodiment of the present invention. The sensor apparatus of this embodiment is different from that of the second embodiment in that the display device 50 is disposed so as to be opposed to the front surface of the sensor unit 10. The sensor unit 10 is supported by a chassis 60 disposed in a casing.

Also in this embodiment, it is possible to detect the finger F in proximity to the sensor unit 10 with high sensitivity. Therefore, even in the case where the display device 50 is intervened between the sensor unit 10 and the finger F, the proximity of the finger and the movement thereof can be detected with high accuracy. Further, according to this embodiment, because the sensor unit 10 is disposed on the back surface side of the display device 50, each of the members does not have to be made of a translucent material, with the result that the degree of freedom for selection of the material is increased.

### Fourth Embodiment

FIG. 13 is a schematic structural diagram showing a sensor apparatus according to a fourth embodiment of the present invention. The sensor apparatus of this embodiment has an input member 70 and the sensor unit 10. The input member 70 is disposed so as to be opposed to the front surface of the sensor unit 10 and is supported by the chassis 60 disposed in the casing.

The input member 70 is typically formed of a keyboard on which input keys are arranged. According to this embodiment, by holding a hand over the input member 70 or by moving a finger, it is possible to activate a computer or control an image displayed on a display screen (not shown). For example, in this embodiment, by moving a finger immediately above the input member 70, a pointer displayed on the display screen is moved, and a touching operation with respect to the input member 70 causes the pointer to be fixed in position. Thus, the movement control of the pointer can be performed without performing a key input operation with the use of the input member 70.

The embodiments of the present invention are described above. However, the present invention is not limited to those and can be variously changed on the basis of the technical idea of the present invention.

For example, in the above embodiments, the sensor unit 10 is formed in a flat form, but is not limited to this. The sensor unit may have a curved surface shape.

Further, in the above embodiments, the sensor unit 10 has the detection electrodes 10x and 10y in the X-axis direction and the Y-axis direction, respectively. In addition to this, the present invention is applicable to a sensor apparatus in which detection electrodes are disposed in one of the X-axis direction and Y-axis direction. Furthermore, the detection electrodes are not limited to the wiring electrodes but may be point electrodes.

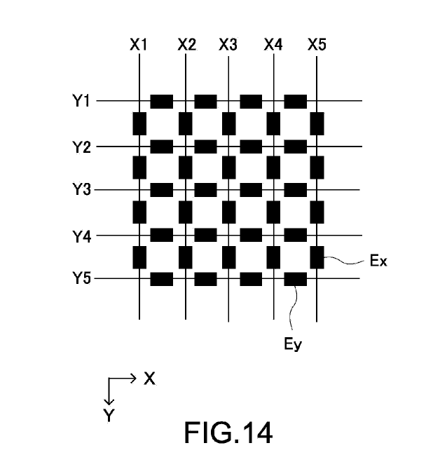

Alternatively, as shown in FIG. 14, wide electrode areas Ex and Ey may be formed in parts except crossing areas of detection electrodes X1 to X5 arranged in an X-axis direction and detection electrodes Y1 to Y5 arranged in a Y-axis direction, respectively. With this structure, it is possible to further improve the detection sensitivity of the detection electrodes.

Further, in the above embodiments, as the calculation unit for calculating the distance between the detection target object and the sensor unit, the calculation circuit for calculating the distance on the basis of the capacitance of the oscillation electrode. Instead, the distance can also be calculated with the use of an image pickup device for taking an image of the detection target object, an infrared detection device for sensing the heat of a person, or the like.

The present application contains subject matter related to that disclosed in Japanese Priority Patent Application JP 2010-103620 filed in the Japan Patent Office on Apr. 28, 2010, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A sensor apparatus, comprising:
a sensor unit configured to have a plurality of detection electrodes each having a capacitance that is changed by proximity of a detection target object;
a calculation unit configured to calculate a first distance, the first distance being a distance between the detection target object and the sensor unit;
a switch circuit unit capable of switching the plurality of detection electrodes between a first state and a second state, and configured to select at least two detection electrodes one by one that are switched from the second state to the first state from among the plurality of detection electrodes, the first state being a state in which a signal voltage for detecting the capacitance is supplied, the second state being an electrically floating state; and
a control unit configured to control the switch circuit unit to cause a second distance to correspond to the first distance calculated by the calculation unit, the second distance being a distance between the detection electrodes switched from the second state to the first state.

2. The sensor apparatus according to claim 1, wherein
the plurality of detection electrodes each are configured to have a plurality of first electrode units arranged at a first interval in a first direction, and
the control unit is configured to control the switch circuit unit to change the second distance by an integral multiple of the first interval in accordance with the first distance.

3. The sensor apparatus according to claim 2, wherein
the plurality of detection electrodes each are configured to further have a plurality of second electrode units arranged at a second interval in a second direction that intersects the first direction, and
the control unit is configured to control the switch circuit unit to change the second distance by an integral multiple of the second interval in accordance with the second distance.

4. The sensor apparatus according to claim 1, further comprising
a display device disposed to be opposed to the sensor unit, and configured to have a display surface that displays information.

5. The sensor apparatus according to claim 1, further comprising
an input member disposed to be opposed to the sensor unit, and capable of inputting information.

6. An information display apparatus, comprising:
a sensor unit configured to have a plurality of detection electrodes each having a capacitance that is changed by proximity of a detection target object;
a calculation unit configured to calculate a first distance, the first distance being a distance between the detection target object and the sensor unit;
a switch circuit unit capable of switching the plurality of detection electrodes between a first state and a second state, and configured to select at least two detection electrodes one by one that are switched from the second state to the first state from among the plurality of detection electrodes, the first state being a state in which a signal voltage for detecting the capacitance is supplied, the second state being an electrically floating state;
a control unit configured to control the switch circuit unit to cause a second distance to correspond to the first distance calculated by the calculation unit, the second distance being a distance between the detection electrodes switched from the second state to the first state; and
a display device disposed to be opposed to the sensor unit, and configured to have a display surface that displays information.
